(19) United States
(12) Patent Application Publication
(10) Pub. No.: US 2016/0165148 A1
(43) Pub. Date: Jun. 9, 2016

(54) IMAGE SYNTHESIZER FOR VEHICLE

(71) Applicant: DENSO CORPORATION, Aichi (JP)

(72) Inventors: Arata Itoh, Kariya-city (JP); Muneaki Matsumoto, Kariya-city (JP)

(73) Assignee: DENSO CORPORATION, Kariya-city, Aichi-pref (JP)

(21) Appl. No.: 14/903,565

(22) PCT Filed: Jul. 8, 2014
(86) PCT No.: PCT/JP2014/003615

§ 371 Date: Jan. 7, 2016

(30) Foreign Application Priority Data
Jul. 11, 2013 (JP) 2013-145593

(51) Int. Cl. H04N 5/265; H04N 5/247; G06T 7/00; G06K 9/00; G06T 7/40; G06K 9/52; G06T 7/60; B60R 1/00; G06K 9/46

(52) U.S. Cl. CPC H04N 5/265; B60R 1/00; H04N 5/247; G06T 7/0085; G06K 9/4604; G06K 9/4652; G06T 7/408; G06K 9/52; G06T 7/60; G06T 7/0042; G06K 9/00791; G06T 2207/20212; G06T 2207/30168; G06T 2207/30252

(57) ABSTRACT

An image synthesizer apparatus for vehicle includes an image generator and an error detector. From multiple cameras arranged to a vehicle so that an imaging region of each camera partially overlaps with an imaging region of an adjacent camera, the image generator acquires images of areas allocated to the respective cameras, and synthesizes the acquired images to generate a synthetic image around the vehicle viewed from a viewpoint above the vehicle. The error detector detects errors in the cameras. When the error detector detects a faulty camera in the cameras, the image generator acquires, from the image captured by the camera adjacent to the faulty camera, an overlap portion overlapping with the image captured by the faulty camera, uses the overlap portion to generate the synthetic image, and applies image reinforcement to the overlap portion.

### CROSS REFERENCE TO RELATED APPLICATION

This application is based on Japanese Patent Application No. 2013-145593 filed on Jul. 11, 2013, the disclosure of which is incorporated herein by reference.

### TECHNICAL FIELD

The present disclosure relates to an image synthesizer apparatus for vehicle.

### BACKGROUND ART

There is known a technology that installs several cameras at a front, a rear, a left and a right of a vehicle and generates a synthetic image around the vehicle. The technology generates a synthetic image around the vehicle viewed from a viewpoint above the vehicle by applying a viewpoint conversion process to images around the vehicle captured by the cameras.

There is a proposed technology that in case of failure of at least one of the cameras, enlarges an image captured by another camera adjacent to the failed camera to decrease an area not displayed in a synthetic image (see patent literature 1).

According to investigations of the inventors of the present application, the technology described in patent literature 1 uses a peripheral part of the image captured by the adjacent camera to complement part of an area covered by the failed camera. In some cases, the peripheral part of the image may be lower in resolution than a central part. Thus, the part of the synthetic image complemented by the camera adjacent to the failed camera may have decreased resolution. In this case, a driver may misinterpret that the resolution of the complemented part is equal to the resolution of the other parts, and may overlook a target existing in the complemented part.

### PRIOR ART LITERATURES

### Patent Literature

Patent Literature 1: JP-2007-89082 A

### SUMMARY OF INVENTION

In consideration of the foregoing, it is an object of the present disclosure to provide an image synthesizer apparatus for vehicle.

In an example of the present disclosure, an image synthesizer apparatus for vehicle comprises an image generator that, from a plurality of cameras arranged to a vehicle so that an imaging region of each camera partially overlaps with an imaging region of an adjacent camera, acquires images of areas allocated to the respective cameras, and synthesizes the acquired images to generate a synthetic image around the vehicle viewed from a viewpoint above the vehicle.

The image synthesizer apparatus for vehicle further comprises an error detector that detects errors in the cameras. when the error detector detects a faulty camera in the cameras, the image generator acquires, from the image captured by the camera adjacent to the faulty camera, an overlap portion overlapping with the image captured by the faulty camera, uses the overlap portion to generate the synthetic image, and applies image reinforcement to the overlap portion.

According to the image synthesizer apparatus for vehicle, because the image reinforcement is applied to the overlap portion, the overlap portion (the portion that may have the decreased resolution) in the synthetic image can be easily recognized.

### BRIEF DESCRIPTION OF DRAWINGS

FIG. 1 is a block diagram illustrating a configuration of an image synthesizer apparatus for vehicle;

FIG. 2 is an explanatory diagram illustrating placement of cameras on a vehicle and imaging regions viewed from an upper viewpoint;

FIG. 3 is a flowchart illustrating an overall process performed by the image synthesizer apparatus for vehicle;

FIG. 4 is a flowchart illustrating a synthetic image generation process in normal state performed by the image synthesizer apparatus for vehicle;

FIG. 5 is a flowchart illustrating the synthetic image generation process in abnormal state performed by the image synthesizer apparatus for vehicle;

FIG. 6A is an explanatory diagram illustrating a synthetic image generated by the synthetic image generation process in normal state;

FIG. 6B is a diagram corresponding to the synthetic image in FIG. 6A generated by the synthetic image generation process in normal state;

FIG. 7A is an explanatory diagram illustrating a synthetic image generated by the synthetic image generation process in abnormal state;

FIG. 7B is a diagram corresponding to the synthetic image in FIG. 7A generated by the synthetic image generation process in abnormal state;

FIG. 8A an explanatory diagram illustrating another synthetic image generated by the synthetic image generation process in abnormal state;

FIG. 8B is another diagram corresponding to the synthetic image in FIG. 8A generated by the synthetic image generation process in abnormal state;

FIG. 9A an explanatory diagram illustrating still another synthetic image generated by the synthetic image generation process in abnormal state;

FIG. 9B is still another diagram corresponding to the synthetic image in FIG. 9A generated by the synthetic image generation process in abnormal state; and

FIG. 10 is an explanatory diagram illustrating placement of cameras on a vehicle and imaging regions viewed from an upper viewpoint.

### EMBODIMENTS FOR CARRYING OUT INVENTION

Embodiments of the disclosure will be described with reference to the accompanying drawings.

### First Embodiment

1. Configuration of an Image Synthesizer Apparatus for Vehicle 1

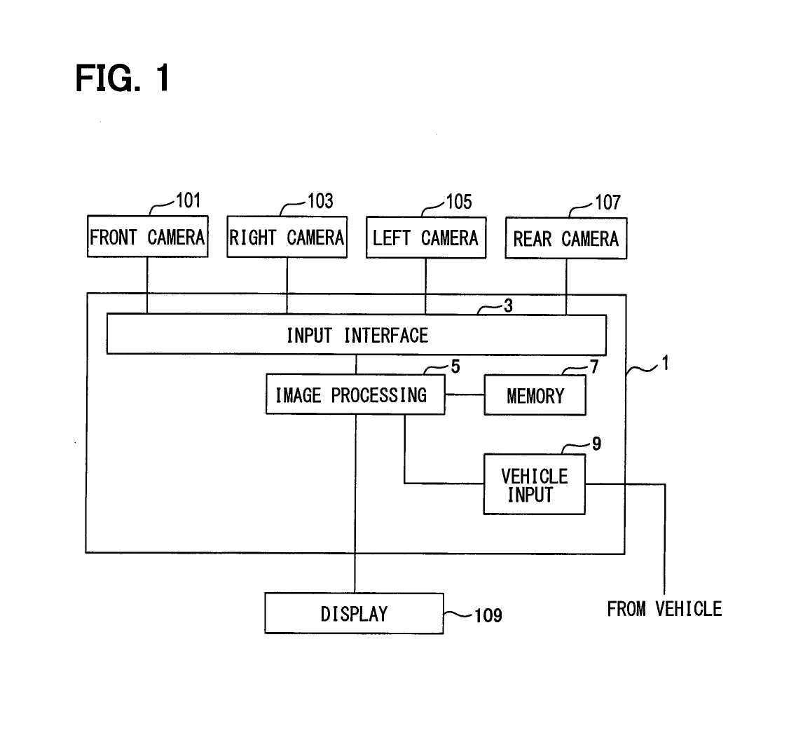

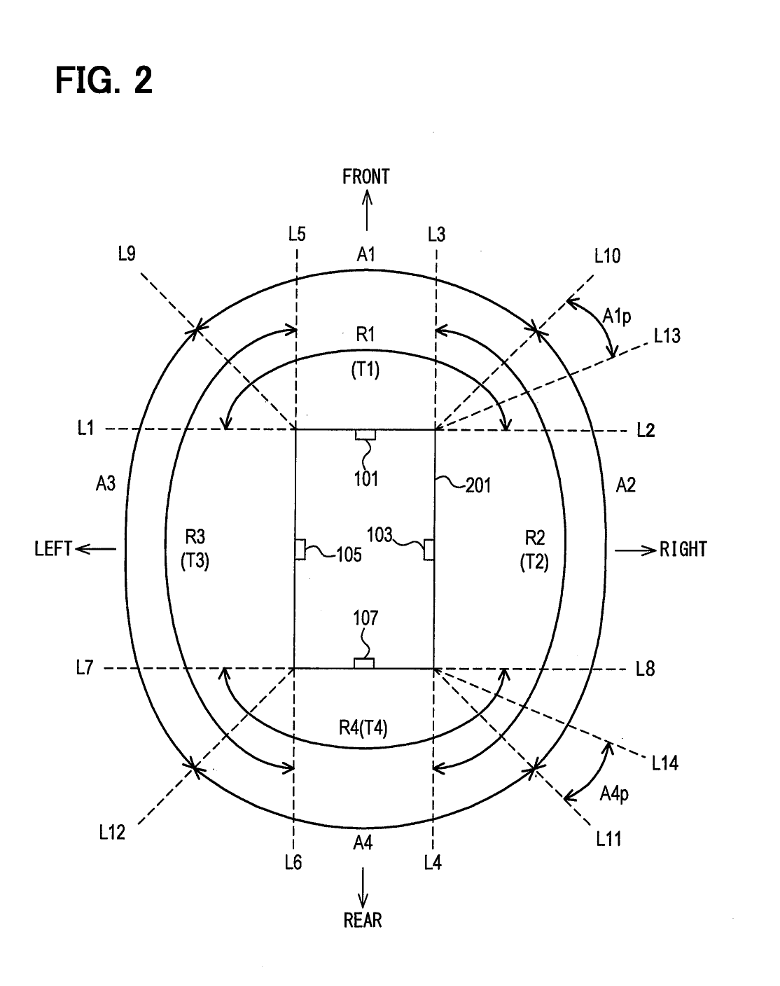

The description below explains the configuration of the image synthesizer apparatus for vehicle 1 based on FIGS. 1 and 2. The image synthesizer apparatus for vehicle 1 is mounted on a vehicle. The image synthesizer apparatus for vehicle 1 includes an input interface 3, an image processing portion 5, memory 7, and a vehicle input portion 9.

The input interface 3 is supplied with image signals from a front camera 101, a right camera 103, a left camera 105, and a rear camera 107.

The image processing portion 5 is provided by a well-known computer. The image processing portion 5 includes a processing unit and a storage unit. The processing unit performs a program stored in the storage unit to perform processes to be described later and generate a synthetic image. The synthetic image covers an area around the vehicle viewed from a viewpoint above the vehicle. The image processing portion 5 outputs the generated synthetic image to a display 109. The display 109 is provided as a liquid crystal display that is positioned in a vehicle compartment to be audiovisually accessed by a driver and displays a synthetic image. The storage unit storing the programs is provided as a non-transitory computer-readable storage medium.

The memory 7 stores various types of data. Various types of data are stored in the memory 7 when the image processing portion 5 generates a synthetic image. The vehicle input portion 9 is supplied with various types of information from the vehicle. The information includes a steering angle (direction), a vehicle speed, and shift pattern information indicating whether a shift lever is positioned to Park (P), Neutral (N), Drive (D), or Reverse (R).

The image processing portion 5 to perform S11 through S14, S21, S22, and S24 through S27 (to be described later) provides an embodiment of an image generator. The image processing portion 5 to perform S1 (to be described later) provides an embodiment of an error detector. The image processing portion 5 to perform S23 (to be described later) provides an example of a vehicle state acquirer. Each block of the image processing portion 5 may be provided by the processing unit executing a program, by a dedicated processing unit, or by a combination of these. As illustrated in FIG. 2, the front camera 101 is attached to a front end of a vehicle 201. The right camera 103 is attached to a right-side surface of the vehicle 201. The left camera 105 is attached to a left-side surface of the vehicle 201. The rear camera 107 is attached to a rear end of the vehicle 201.

The front camera 101, the right camera 103, the left camera 105, and the rear camera 107 each include a fish-eye lens capable of a 180° imaging region. The front camera 101 provides imaging region R1 from line L1 to line L2 so that the region covers an area from the front end of the vehicle 201 to the left of the vehicle 201 and covers an area from the front end of the vehicle 201 to the right of the vehicle 201.

The right camera 103 provides imaging region R2 from line L3 to line L4 so that the region covers an area from a right end of the vehicle 201 to the front of the vehicle 201 and covers an area from the right end of the vehicle 201 to the rear of the vehicle 201.

The left camera 105 provides imaging region R3 from line L5 to line L6 so that the region covers an area from a left end of the vehicle 201 to the front of the vehicle 201 and covers an area from the left end of the vehicle 201 to the rear of the vehicle 201.

The rear camera 107 provides imaging region R4 from line L7 to line L8 so that the region covers an area from the rear end of the vehicle 201 to the left of the vehicle 201 and covers an area from the rear of the vehicle 201 to the right of the vehicle 201.

Imaging region R1 for the front camera 101 partially overlaps with imaging region R2 for the right camera 103 adjacent to the front camera 101 in the area between line L2 and the line L3.

Imaging region R1 for the front camera 101 partially overlaps with imaging region R3 for the left camera 105 adjacent to the front camera 101 in the area between line L1 and the line L5.

Imaging region R2 for the right camera 103 partially overlaps with imaging region R4 for the rear camera 107 adjacent to the right camera 103 in the area between line L4 and the line L8.

Imaging region R3 for the left camera 105 partially overlaps with imaging region R4 for the rear camera 107 adjacent to the left camera 105 in the area between line L6 and the line L7.

The resolution of the peripheral part of the imaging regions for the front camera 101, the right camera 103, the left camera 105, and the rear camera 107 is lower than the resolution of the central part of the imaging region.

2. Processes Executed by the Image Synthesizer Apparatus for Vehicle 1

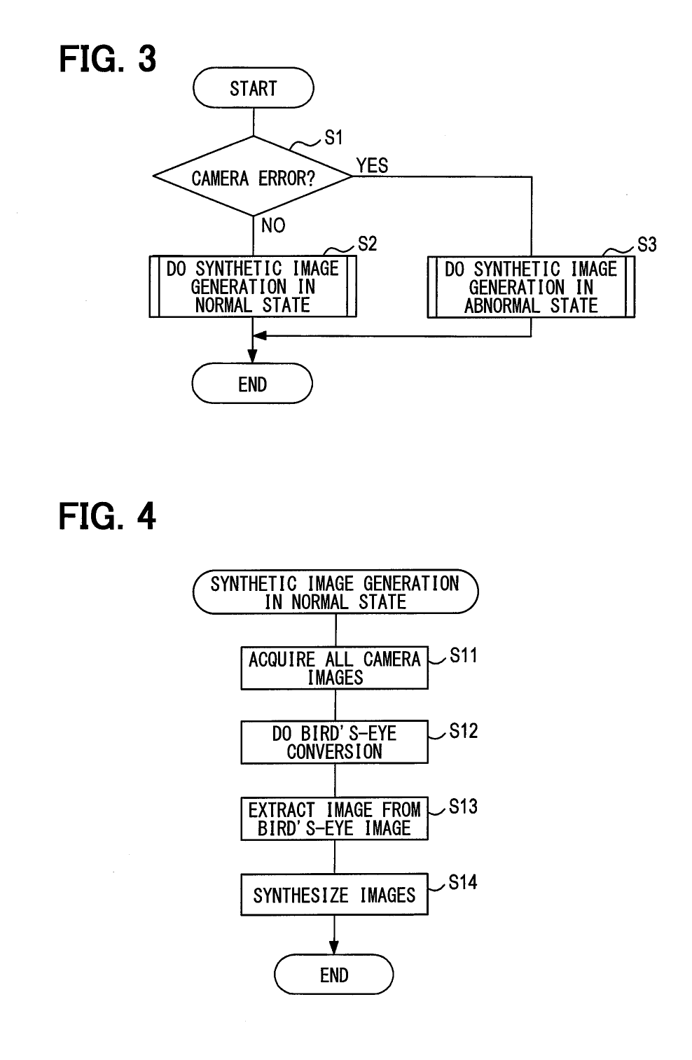

With reference to FIGS. 3 through 7B, the description below explains processes performed by the image synthesizer apparatus for vehicle 1 (specifically, the image processing portion 5). At S1 in FIG. 3, it is determined whether the front camera 101, the right camera 103, the left camera 105, or the rear camera 107 causes an error.

As the error, there is a case where the camera fails and disables any capture, and a case where too large a stain adheres to a camera lens while the capture is available. The camera failure can be detected by determining whether or not the camera inputs a signal (e.g., NTSC signal or synchronization signal) to the input interface 3.

The stain on the lens can be detected by determining whether or not an image from the camera contains a thing whose position remains unchanged in the image over time during travel of the vehicle. The process proceeds to S2 if none of the front camera 101, the right camera 103, the left camera 105, and the rear camera 107 causes any error. The process proceeds to S3 if at least one of the front camera 101, the right camera 103, the left camera 105, and the rear camera 107 causes an error.

At S2, a synthetic image generation process in normal state is performed. This synthetic image generation process will be described with reference to FIG. 4. At S11, images captured by the front camera 101, the right camera 103, the left camera 105, and the rear camera 107 are acquired. The acquired image corresponds to the entire imaging regions. Specifically, an image acquired from the front camera 101 corresponds to the entire imaging region R1. An image acquired from the right camera 103 corresponds to the entire imaging region R2. An image acquired from the left camera 105 corresponds to the entire imaging region R3. An image acquired from the rear camera 107 corresponds to the entire imaging region R4.

At S12, bird's-eye conversion is applied to the image acquired at S11 (to convert the image into an image viewed from a virtual viewpoint above the vehicle) using a known image conversion (viewpoint conversion) process. An image obtained by applying the bird's-eye conversion to the image of imaging region R1 is referred to as bird's-eye image T1. An image obtained by applying the bird's-eye conversion to the image of imaging region R2 is referred to as bird's-eye image T2. An image obtained by applying the bird's-eye conversion to the image of imaging region R3 is referred to as bird's-eye image T3. An image obtained by applying the bird's-eye conversion to the image of imaging region R4 is referred to as bird's-eye image T4.

At S13, images A1 through A4 are extracted from bird's-eye image T1 through T4. Image A1 is an image of an area from line L9 to line L10 in bird's-eye image T1 (see FIG. 2). Line L9 equally divides an angle (90°) between lines L1 and L5 at the front left corner of the vehicle 201. Line L9 equally divides an angle (90°) between lines L2 and L3 at the front right corner of the vehicle 201.

Image A2 is an image of an area from line L10 to line L11 in bird's-eye image T2. Line L11 equally divides an angle (90°) between lines L4 and L8 at the back right corner of the vehicle 201.

Image A3 is an image of an area from line L9 to line L12 in bird's-eye image T3. Line L12 equally divides an angle (90°) between lines L6 and L7 at the back left corner of the vehicle 201.

Image A4 is an image of an area from line L11 to line L12 in bird's-eye image T4.

At S14, images A1 through A4 are synthesized to complete a synthetic image around the vehicle viewed from the viewpoint above the vehicle 201.

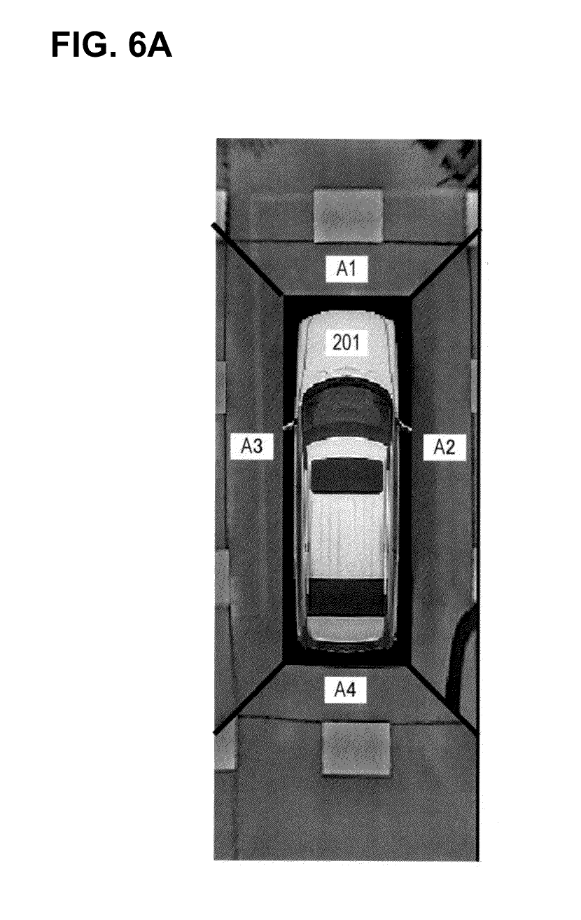

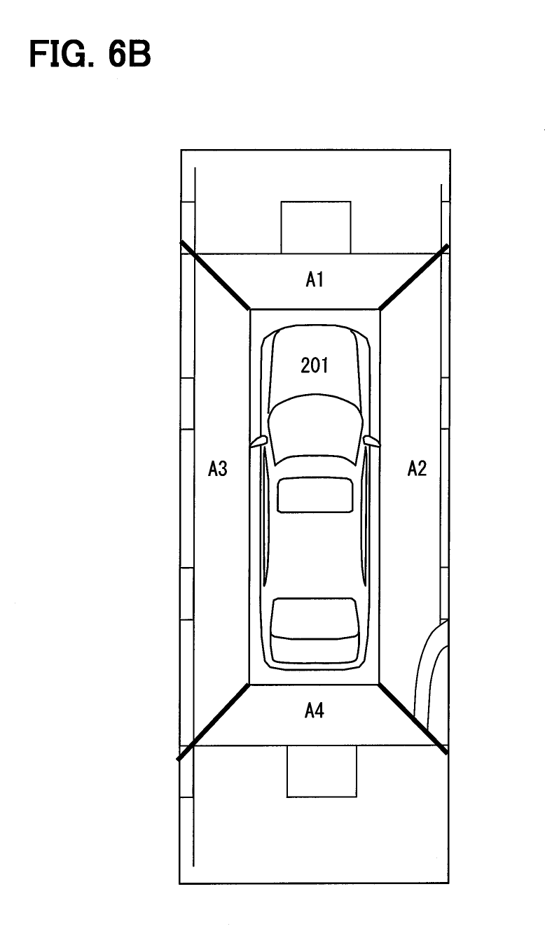

FIGS. 6A and 6B illustrate synthetic images generated by the synthetic image generation process in normal state.

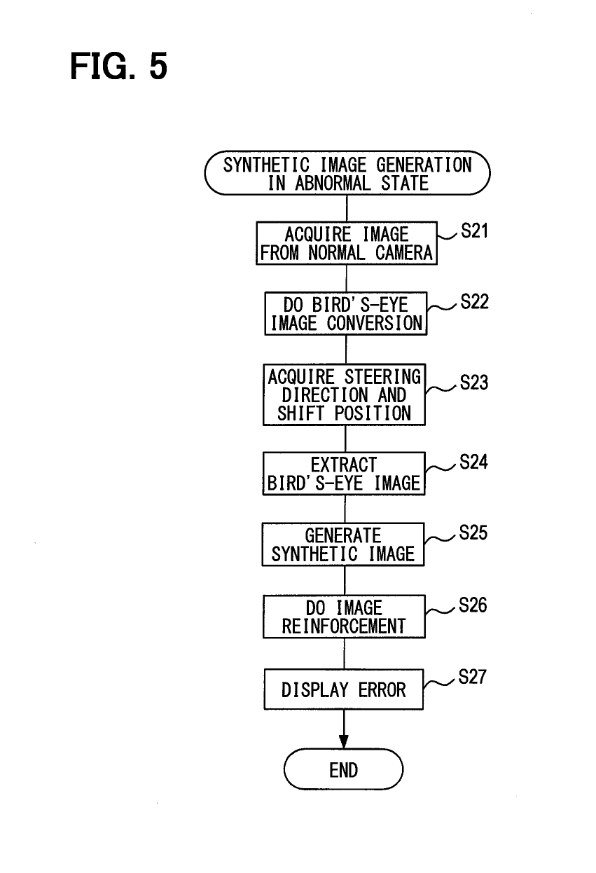

If the determination at S1 in FIG. 3 is affirmed, the process proceeds to S3 to perform the synthetic image generation process in abnormal state. This process will be described based on FIG. 5.

At S21, images are acquired from normal cameras (causing no error) which are the front camera 101, the right camera 103, the left camera 105, or the rear camera 107. The acquired images are images of the entire imaging regions. Specifically, the image acquired from the front camera 101 is an image of the entire imaging region R1. The image acquired from the right camera 103 is an image of the entire imaging region R2. The image acquired from the left camera 105 is an image of the entire imaging region R3. The image acquired from the rear camera 107 is an image of the entire imaging region R4.

At S22, the bird's-eye conversion is applied to the images acquired at S11 using a known image conversion method to generate bird's-eye images T1 through T4 (except an image from a faulty camera).

At S23, a steering direction and a shift position (an embodiment of vehicle state) of the vehicle 201 are acquired based on the signals input to the vehicle input portion 9 from the vehicle.

At S24, part of the bird's-eye image generated at S22 is extracted. Different image extraction methods are used depending on whether a bird's-eye image corresponds to a camera adjacent to the faulty camera or to the other cameras.

The description below explains a case where the right camera 103 is faulty but basically the same process is applicable to cases where other cameras are faulty. When the right camera 103 is faulty, bird's-eye images T1, T3, and T4 are generated at S22. The front camera 101 and the rear camera 107 are adjacent to the right camera 103 and correspond to bird's-eye images T1 and T4.

Similarly to S13, image A3 is extracted from bird's-eye image T3 corresponding to the left camera 105 not adjacent to the right camera 103.

Overlap portion A1p along with image A1 are extracted from bird's-eye image T1 corresponding to the front camera 101 adjacent to the right camera 103. Overlap portion A1p is a portion that belongs to bird's-eye image T1, adjoins image A1, and is closer to line L2 (toward the faulty camera) than image A1. More specifically, overlap portion A1p is an area from line L10 to line L13. Line L13 corresponds to the front right corner of the vehicle 201 and is located between lines L10 and L2. Overlap portion A1p is a portion that overlaps with image A2 extracted from bird's-eye image T2 when the right camera 103 causes no error.

Overlap portion A4p along with image A4 are extracted from bird's-eye image T4 corresponding to the rear camera 107 adjacent to the right camera 103. Overlap portion A4p is a portion that belongs to bird's-eye image T4, adjoins image A4, and is closer to line L8 (toward the faulty camera) than image A4. More specifically, overlap portion A4p is an area from line L11 to line L14. Line L14 corresponds to the rear right corner of the vehicle 201 and is located between lines L8 and L11. Overlap portion A4p is a portion that overlaps with image A2 extracted from bird's-eye image T2 when the right camera 103 causes no error.

The above mentioned lines L13 and L14 are set depending on the steering direction and the shift position acquired at S23. Specifically, a rule in table 1 determines an angle (an area of overlap portion A1p) between lines L13 and L10 and an angle (an area of overlap portion A4p) between lines L14 and L11 according to the steering direction and the shift position. “Large” in table 1 signifies being larger than “standard.”

TABLE 1
RIGHT CAMERA FAILED

| | | STEERING DIRECTION | |
|---|---|---|---|
| | | LEFT | RIGHT |
| SHIFT POSITION | P, N | A1p = DEFAULT, | A1p = DEFAULT, |
| | | A4p = DEFAULT | A4p = DEFAULT |
| | D | A1p = DEFAULT, | A1p = LARGE, |
| | | A4p = DEFAULT | A4p = LARGE |
| | R | A1p = DEFAULT, | A1p = DEFAULT, |
| | | A4p = LARGE | A4p = LARGE |

When the shift position is set to D and the steering direction is right, overlap portions A1p and A4p are larger than the default. This increases the visibility on the right and enables to prevent an accident in which cars making turns hit pedestrians.

When the shift position is set to R and the steering direction is right, overlap portions A4p is larger than the default. This increases the visibility on the rear right and enables to prevent an accident.

When the shift position is set to R and the steering direction is left, overlap portions A4p is larger than the default. This increases the visibility on the rear right and enables to easily confirm a distance to another vehicle on the right.

At S25, the images extracted at S24 are synthesized to generate a synthetic image around the vehicle viewed from a viewpoint above the vehicle 201.

At S26, edge reinforcement (an embodiment of image reinforcement) is applied to overlap portions A1p and A4p in the synthetic image generated at S25. The edge reinforcement forces the luminance contrast in an image to be higher than normal.

At S27, an area (an area between lines L13 and L14 in FIG. 2) that belongs to imaging region R2 of the faulty right camera 103 and that excludes images A1 and A4 and overlap portions A1p and A4p is filled with a predetermined color (e.g., blue) in the synthetic image generated at S25. Additionally, an icon is displayed at the position corresponding to or near the right camera 103 in the synthetic image.

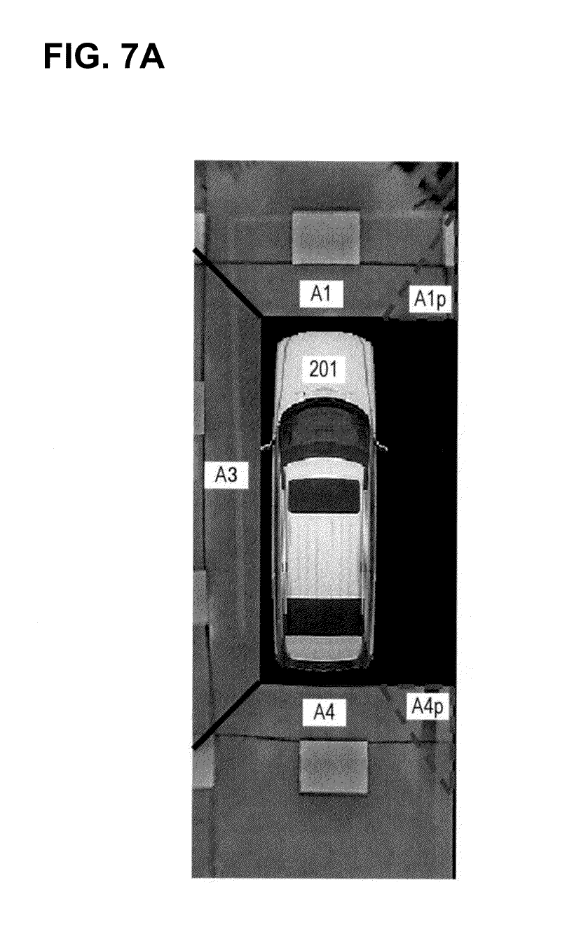

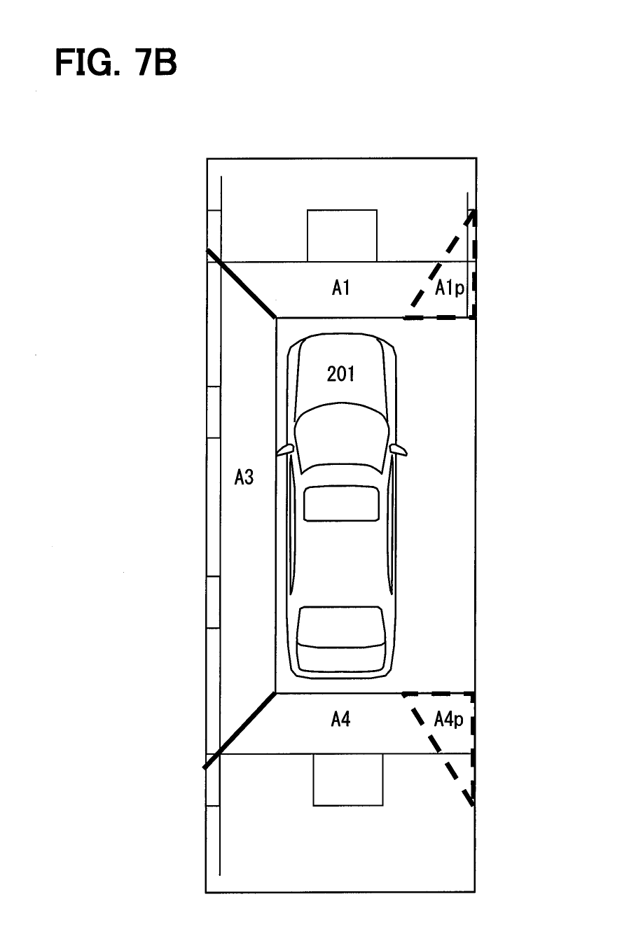

FIGS. 7A and 7B illustrate a synthetic image generated by the synthetic image generation process in abnormal state. The example shows a case where the right camera 103 causes an error. The effect of filling the area with the color and displaying the icon as performed at S27 are omitted from FIGS. 7A and 7B.

The above describes an example where the right camera 103 causes an error. The below describes an example where the front camera 101 causes an error. While the basic process flow is similar to the case where the right camera 103 causes an error, bird's-eye images T2 through T4 are generated at S22. At S24, similarly to S13, image A4 is extracted from the rear camera 107 not adjacent to the front camera 101.

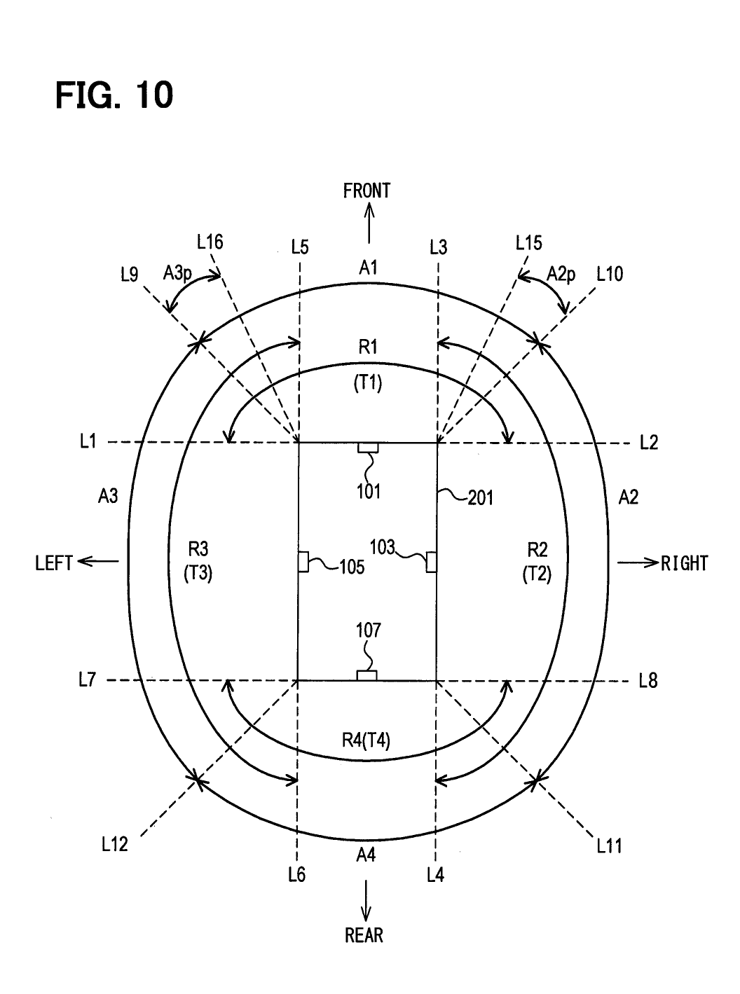

As illustrated in FIG. 10, overlap portion A2p along with image A2 are extracted from bird's-eye image T2 corresponding to the right camera 103 adjacent to the front camera 101. Overlap portion A2p belongs to bird's-eye image T2, adjoins image A2, and is closer to line L3 (toward the faulty camera) than image A2. More specifically, overlap portion A2p is an area from line L10 to line L15. Line L15 corresponds to the front right corner of the vehicle 201 and is located between lines L10 and L3. Overlap portion A2p is a portion that overlaps with image A1 extracted from bird's-eye image T1 when the front camera 101 causes no error.

Overlap portion A3p along with image A3 are extracted from bird's-eye image T3 corresponding to the left camera 105 adjacent to the front camera 101. Overlap portion A3p belongs to bird's-eye image T3, adjoins image A3, and is closer to line L5 (toward the faulty camera) than image A3. More specifically, overlap portion A3p is an area from line L9 to line L16. Line L16 corresponds to the front left corner of the vehicle 201 and is located between lines L5 and L9. Overlap portion A3p is a portion that overlaps with image A1 extracted from bird's-eye image T1 when the front camera 101 causes no error.

Lines L15 and L16 are set depending on the steering direction and the shift position acquired at S23. A rule in table 2 determines an angle (an area of overlap portion A2p) between lines L10 and L15 and an angle (an area of overlap portion A3p) between lines L9 and L16 according to the steering direction and the shift position.

TABLE 2
FRONT CAMERA FAILED

| | | STEERING DIRECTION | |
|---|---|---|---|
| | | LEFT | RIGHT |
| SHIFT POSITION | P, N | A2p = DEFAULT, | A2p = DEFAULT, |
| | | A3p = DEFAULT | A3p = DEFAULT |
| | D | A2p = DEFAULT, | A2p = LARGE, |
| | | A3p = LARGE | A3p = DEFAULT |
| | R | A2p = DEFAULT, | A2p = DEFAULT, |
| | | A3p = DEFAULT | A3p = DEFAULT |

When the shift position is set to D and the steering direction is right, overlap portion A2p is larger than the default. This increases the visibility on the right and enables to prevent an accident.

When the shift position is set to D and the steering direction is left, overlap portion A3p is larger than the default. This increases the visibility on the left and enables to prevent an accident.

At S26, edge reinforcement (an embodiment of image reinforcement) is applied to overlap portions A2p and A3p in the synthetic image generated at S25. The edge reinforcement forces the luminance contrast in an image to be higher than normal.

At S27, an area (an area between lines L15 and L16 in FIG. 10) that belongs to imaging region R1 of the faulty front camera 101 and excludes images A2 and A3 and overlap portions A2p and A3p is filled with a predetermined color (e.g., blue) in the synthetic image generated at S25. Additionally, an icon is displayed at the position corresponding to or near the front camera 101 in the synthetic image.

3. Effects of the Image Synthesizer Apparatus for Vehicle 1

(1) Even if some of the cameras causes an error, the image synthesizer apparatus for vehicle 1 can reduce a non-display area in the synthetic image by using an image from the adjacent camera.

(2) The image synthesizer apparatus for vehicle 1 applies the edge reinforcement process to overlap portions A1p, A2p, A3p, and A4p. Thus, a driver can easily recognize overlap portions A1p, A2p, A3p, and A4p in the synthetic image. The driver can easily view a target in overlap portion A1p, A2p, A3p, or A4p even if overlap portion A1p, A2p, A3p, or A4p indicates low resolution.

(3) The image synthesizer apparatus for vehicle 1 configures sizes of overlap portions A1p, A2p, A3p, and A4p in accordance with a steering direction and a shift position. This ensures a proper area of visibility in accordance with the steering direction and the shift position. The driver can more easily view a target around the vehicle.

(4) The image synthesizer apparatus for vehicle 1 fills the imaging region of a faulty camera with a color and displays an icon at the position corresponding to or near the faulty camera. The driver can easily recognize whether or not a camera error occurs and which camera causes an error.

### Second Embodiment

1. Configuration of the Image Synthesizer Apparatus for Vehicle 1 and Processes to be Performed

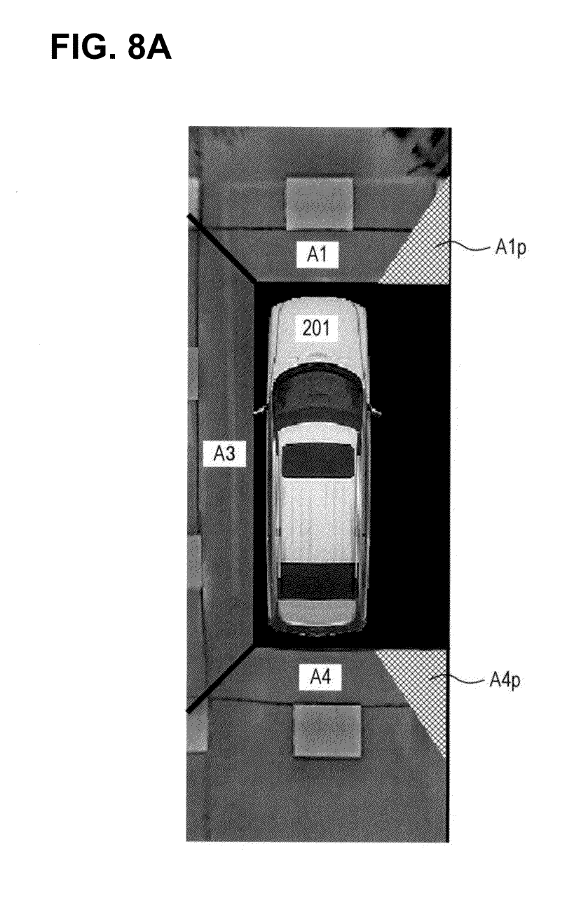

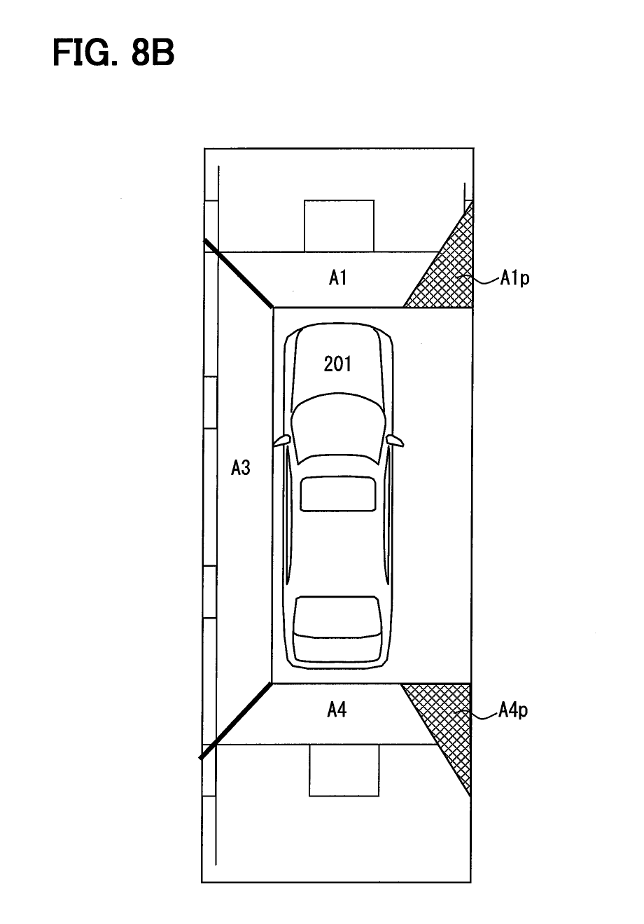

The image synthesizer apparatus for vehicle 1 according to the second embodiment provides basically the same configuration and processes as the first embodiment. However, the second embodiment replaces the edge reinforcement with a process to change colors (an embodiment of image reinforcement), with regard to a process performed on overlap portions A1p, A2p, A3p, and A4p at S26. FIGS. 8A and 8B illustrate synthetic images generated by changing the color of overlap portions A1p and A4p. The example shows a case where the right camera 103 causes an error. The example heightens the blue color originally used for overlap portions A1p and A4p.

A transparent color is applied to overlap portions A1p and A4p. Therefore, the driver can view a target present in overlap portions A1p and A4p. Gradation may be applied to the color of overlap portions A1p and A4p. The color may be gradually varied around a boundary between overlap portion A1p and image A1. Similarly, the color may be gradually varied around a boundary between overlap portion A4p and image A4.

2. Effects of the Image Synthesizer Apparatus for Vehicle 1

(1) The image synthesizer apparatus for vehicle 1 provides almost the same effects as the first embodiment.

(2) The image synthesizer apparatus for vehicle 1 performs the process to change the color of overlap portions A1p, A2p, A3p, and A4p. The driver can easily recognize overlap portions A1p, A2p, A3p, and A4p in a synthetic image.

### Third Embodiment

1. Configuration of the Image Synthesizer Apparatus for Vehicle 1 and Processes to be Performed

The image synthesizer apparatus for vehicle 1 according to the third embodiment provides basically the same configuration and processes as the first embodiment. However, the third embodiment is independent of the vehicle's steering direction or shift position and uses a constant size and area for overlap portions A1p, A2p, A3p, and A4p.

Overlap portion A1p does not include an outermost part of the imaging region R1 of the front camera 101. In FIG. 2, line L13 defining an outer edge of overlap portion A1p does not match line L2 defining an outer edge of imaging region R1. Overlap portion A4p does not include an outermost part of the imaging region R4 of the rear camera 107. In FIG. 2, line L14 defining an outer edge of overlap portion A4p does not match line L2 defining an outer edge of imaging region R4.

Overlap portion A2p does not include an outermost part of imaging region R2 of the right camera 103. In FIG. 10, line L15 defining an outer edge of overlap portion A2p does not match line L3 defining an outer edge of imaging region R2. Overlap portion A3p does not include an outermost part of imaging region R3 of the left camera 105. In FIG. 10, line L16 defining an outer edge of overlap portion A3p does not match line L5 defining an outer edge of imaging region R3.

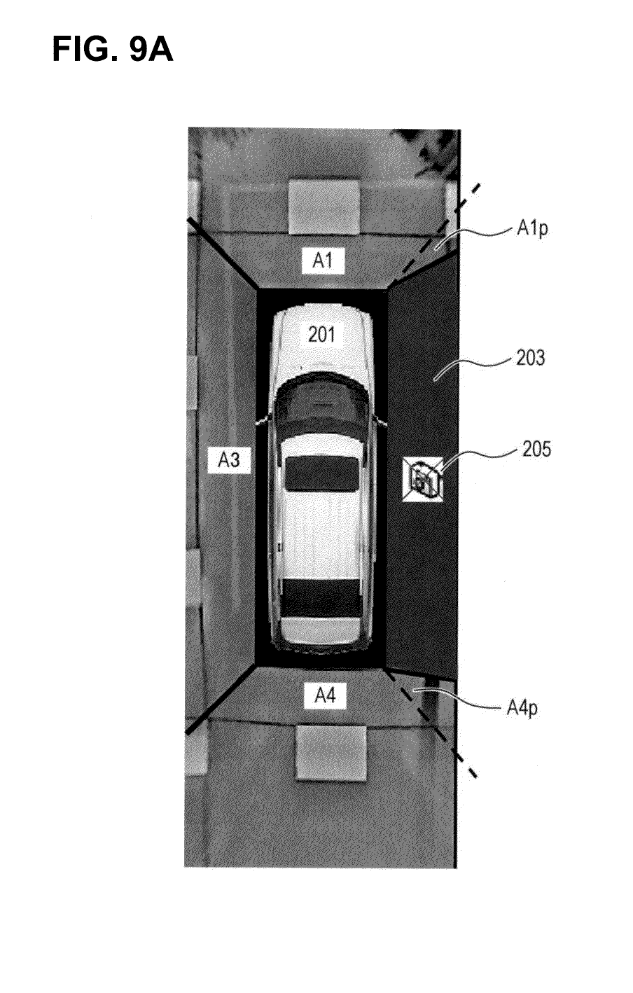

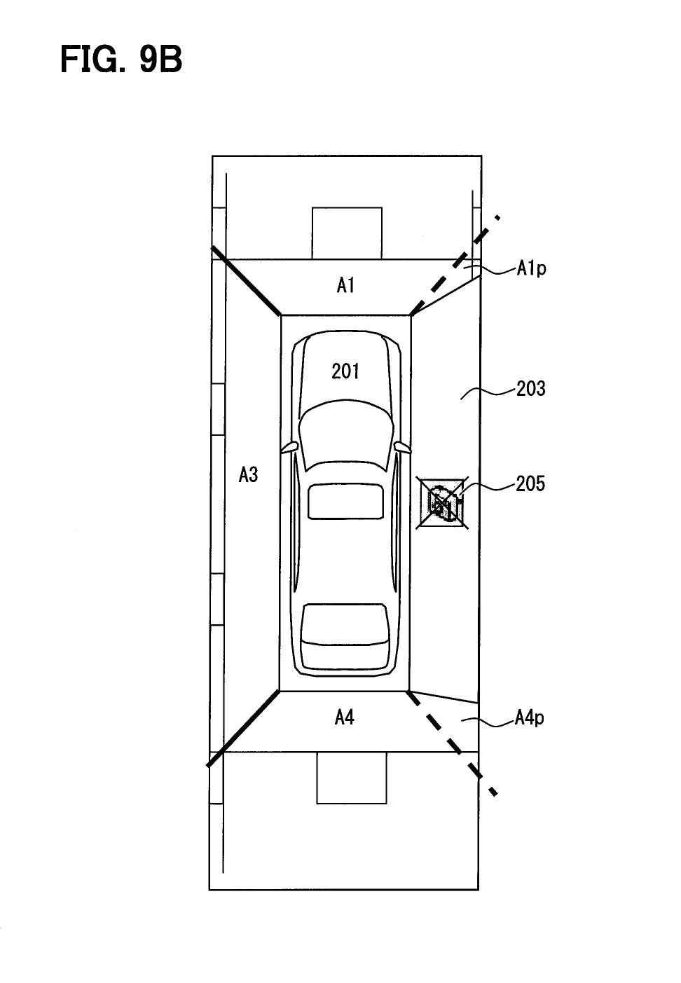

FIGS. 9A and 9B illustrate synthetic images containing overlap portions A1p and A4p generated by excluding the outermost part from the imaging region of the camera. The example shows a case where the right camera 103 causes an error. In this synthetic image example, the image synthesizer apparatus for vehicle 1 performs a process (an embodiment of specified display) to fill a hidden area 203 with a specified color. The hidden area 203 belongs to imaging region R2 of the faulty right camera 103 and is not covered by the images A1 and A4 and overlap portions A1p and A4p. The image synthesizer apparatus for vehicle 1 displays an icon 205 (an embodiment of specified display) near the position corresponding to the right camera 103.

2. Effects of the Image Synthesizer Apparatus for Vehicle 1

(1) The image synthesizer apparatus for vehicle 1 provides almost the same effects as the first embodiment.

(2) Overlap portions A1p, A2p, A3p, and A4p do not contain an outermost part (highly likely to cause low resolution) of the imaging region for the camera and indicate high resolution. The image synthesizer apparatus for vehicle 1 according to the embodiment can prevent a low-resolution part from being generated in a synthetic image.

### Fourth Embodiment

1. Configuration of the Image Synthesizer Apparatus for Vehicle 1 and Processes to be Performed

The image synthesizer apparatus for vehicle 1 according to the fourth embodiment provides basically the same configuration and processes as the first embodiment. However, the fourth embodiment acquires a vehicle speed at S23. At S24, the image synthesizer apparatus for vehicle 1 sets sizes of overlap portions A1p, A2p, A3p, and A4p. Decreasing the vehicle speed increases overlap portions A1p, A2p, A3p, and A4p.

2. Effects of the Image Synthesizer Apparatus for Vehicle 1

(1) The image synthesizer apparatus for vehicle 1 provides almost the same effects as the first embodiment.

(2) Decreasing a vehicle speed increases overlap portions A1p, A2p, A3p, and A4p. The driver can easily confirm a surrounding situation when the vehicle travels at a low speed.

It is to be distinctly understood that embodiments of the present disclosure are not limited to the above-illustrated embodiments and covers various forms.

For example, the number of cameras is not limited to four but may be set to three, five, six, eight etc.

The imaging region for cameras is not limited to 180° but may be wider or narrower.

The image reinforcement may be replaced by other processes such as periodically varying luminance, lightness, or color.

The error at S1 may signify one of the camera failure and the lens contamination.

The angles formed by lines L9, L10, L11, L12, L13, L14, L15, and L16 in FIG. 2 are not limited to the above but may be specified otherwise.

At S24 in the first and second embodiments, the sizes of overlap portions A1p, A2p, A3p, and A4p may be configured based on conditions other than those specified in Tables 1 and 2.

At S24 in the first and second embodiments, the sizes of overlap portions A1p, A2p, A3p, and A4p may be configured in accordance with one of the steering direction and the shift position. Suppose that right camera 103 causes an error. When the steering direction is right, the sizes of overlap portions A1p and A4p can be set to be larger than the default regardless of the shift position.

At S24 in the first and second embodiments, the sizes of overlap portions A1p, A2p, A3p, and A4p may be configured in accordance with a combination of the steering direction, the shift position, and the vehicle speed.

At S24 in the first and second embodiments, the sizes of overlap portions A1p, A2p, A3p, and A4p may be configured in accordance with a combination of the steering direction and the vehicle speed.

At S24 in the first and second embodiments, the sizes of overlap portions A1p, A2p, A3p, and A4p may be configured in accordance with a combination of the shift position and the vehicle speed.

All or part of the configurations in the first through fourth embodiments may be combined as needed. In the first and second embodiments, the area of overlap portions A1p, A2p, A3p, and A4p may conform to the third embodiment (i.e., the camera imaging region except its outermost part).

While there have been described specific embodiments and configurations of the present disclosure, it is to be distinctly understood that the embodiments and configurations of the disclosure are not limited to those described above. The scope of embodiments and configurations of the disclosure also covers an embodiment or a configuration resulting from appropriately combining technical elements disclosed in different embodiments or configurations. Part of each embodiment and configuration is also an embodiment of the present disclosure.

1. An image synthesizer apparatus for vehicle comprising:
an image generator that,
from a plurality of cameras arranged to a vehicle so that an imaging region of each camera partially overlaps with an imaging region of an adjacent camera, acquires images of areas allocated to the respective cameras, and
synthesizes the acquired images to generate a synthetic image around the vehicle viewed from a viewpoint above the vehicle; and
an error detector that detects errors in the cameras,
wherein
when the error detector detects a faulty camera in the cameras, the image generator acquires, from the image captured by the camera adjacent to the faulty camera, an overlap portion overlapping with the image captured by the faulty camera, uses the overlap portion to generate the synthetic image, and applies image reinforcement to the overlap portion.

2. The image synthesizer apparatus for vehicle according to claim 1, wherein
the image reinforcement is edge reinforcement and/or color change.

3. The image synthesizer apparatus for vehicle according to claim 1, wherein
the overlap portion does not include an outermost portion of the image captured by the camera adjacent to the faulty camera corresponding to an outermost portion of the imaging area.

4. The image synthesizer apparatus for vehicle according to claim 1, wherein
when the error detector detects a faulty camera in the cameras, the image generator applies specified display to a part of the synthetic image that corresponds to the image captured by the faulty camera.

5. The image synthesizer apparatus for vehicle according to claim 1, further comprising:
a vehicle state acquirer that acquires at least one type of vehicle states selected from a group consisting of a steering direction, a shift position, and a vehicle speed of the vehicle,
wherein
the image generator configures a size of the overlap portion in accordance with the vehicle state.
